(19) United States
(12) Patent Application Publication
(10) Pub. No.: US 2012/0156608 A1
(43) Pub. Date: Jun. 21, 2012

(54) TONER FOR ELECTROSTATIC IMAGE DEVELOPMENT

(75) Inventor: Shingo FUJIMOTO, Tokyo (JP)

(73) Assignee: KONICA MINOLTA BUSINESS TECHNOLOGIES, INC., Tokyo (JP)

(21) Appl. No.: 13/315,485

(22) Filed: Dec. 9, 2011

(30) Foreign Application Priority Data
Dec. 21, 2010 (JP) 2010-284221

(51) Int. Cl. G03G 9/093; G03G 9/16

(52) U.S. Cl. 430/110.2; 430/105

(57) ABSTRACT

A toner for electrostatic image development which is excellent in latitude for environment conditions and is capable of giving prints superior in outputted image stability is disclosed, comprising a resin and a colorant, and the resin comprising a resin (A) having a structural unit represented by the following formula (1) or formula (2).

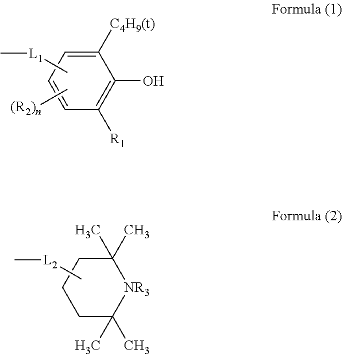

This application claims priority from Japanese Patent Application No. 2010-284221, filed on Dec. 21, 2010, which is incorporated hereinto by reference.

### FIELD OF THE INVENTION

The present invention relates to an electrophotographic toner for use in electrophotographic image forming apparatuses.

### BACKGROUND OF THE INVENTION

Recently, electrophotographic image forming methods have been employed in the field of printing.

Electrophotography is an image forming method in which a toner image is formed on a photoreceptor and the formed toner is transferred to a transfer medium or a recording medium, and an image is finally formed on a recording medium.

In such electrophotography, there were problems such that when forming a toner image on a photoreceptor, active species such as ozone, nitrogen oxide (NO_{X}) or the like which are generated in the step of electrostatic-charging of the photoreceptor, affect the surface latent image formed on a photoreceptor and cause bleeding of an image, leading to image unsharpness.

The thus generated active species come into contact with a toner or a carrier and adversely affect them, such as oxidative degradation, promoting deterioration of the toner or the carrier and leading to a lowering of image quality.

Further, there occurred problems such that, when forming a toner image on a photoreceptor and transferring the toner image to a transfer material, peeling discharge occurs and ozone, nitrogen oxide (NO_{X}) or the like is generated, and thereby or by discharge breakdown, the photoreceptor or the transfer material is damaged, resulting in a lowering of image quality.

Such problems have became larger since the toner particle size recently became smaller for the purpose of achieving enhanced image quality and organic materials which were easily damaged by ozone, nitrogen oxide (NO_{X}) or the like were used for a photoreceptor in place of conventional inorganic materials.

To overcome these problems, there were proposed techniques of incorporation of an antioxidant onto a photoreceptor or incorporation of an antioxidant to a toner (as described in, for example, JP 2003-162100 A, JP 2001-222134 A and JP 2007-010962 A).

Further, there has been known incorporation of an ultraviolet absorber to a toner to achieve efficient transfer of a toner image, in which is known a toner having an antioxidant incorporated to improve a lowering of capability of an antioxidant or the like (as described in, for example, JP 2006-078888 A.

There is also known a technique of incorporation of a light-stability increasing agent containing an antioxidant to a toner containing a dye as a colorant to maintain excellent image characteristics over a long period of time (as described in, for example, JP 2008-052087 A).

However, even when using the foregoing toners, there were still problems such that image quality of the formed image was greatly variable with variation of the image forming environment, and when performing image formation over a long duration, stability of outputted images was not sufficient, such as a lowering of image quality or fogging being easily caused or images being roughened.

### SUMMARY OF THE INVENTION

In light of the foregoing problems, it is an object of the present invention to provide a toner for use in electrostatic image development which is excellent in latitude for environment conditions and is capable of giving prints superior in outputted image stability.

The foregoing object of the present invention can be overcome by the following constitution.

Thus, one aspect of the present invention is directed to a toner for electrostatic image development, wherein the toner comprises a resin and a colorant, and the resin comprising a resin (A) having a structural unit represented by the following formula (1) or formula (2):

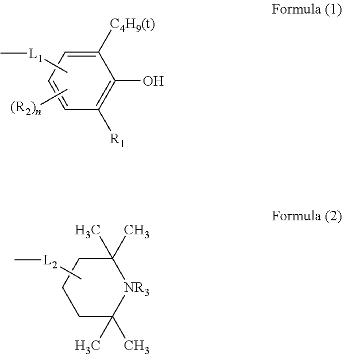

wherein R₁ is a hydrogen atom or an alkyl group having 1 to 8 carbon atoms which may be substituted; R₂ is an alkyl group having 1 to 8 carbon atoms which may be substituted, an alkoxy group having 1 to 8 carbon atoms which may be substituted or a halogen atom; n is an integer of 0 to 2; L₁ is a linkage group or a bond; L₂ is a linkage group or a bond; R₃ is a hydrogen atom, an alkyl group having 1 to 8 carbon atoms which may be substituted, or a linkage group or a bond.

According to the present invention, as described above, there can be provided a toner for electrostatic image development which is excellent in an environment latitude for environmental changes in temperature, humidity or the like, giving images with stable image quality and which is also low in fogging or little or no change in image quality even when performing image formation over a long period of time, giving prints excellent in stability of the outputted images.

### DETAILED DESCRIPTION OF THE INVENTION

The present invention is featured in that a toner for use in electrostatic image development contains at least a resin and a colorant, and the resin comprises a resin (A) having a structural unit represented by the foregoing formula (1) or (2).

In the present invention, there is employed, as a resin used for a toner, a resin containing a constitution unit represented by the above-described formula (1) or (2), that is, a structure with a moiety of an antioxidant in the molecule of the resin (A) and thereby, a toner used for electrostatic image development is provided, rendering it feasible to obtain printing matter of reduced image unsharpness along with reduced fogging and reduced granular appearance of the image, even when performing a large amount of printing over a long period of time.

The toner for electrostatic image development of the present invention (hereinafter, also denoted simply as a toner) contains at least a resin (A) and a colorant and the resin comprises a resin (A) having a constitution unit represented by the foregoing formula (1) or (2). All of the resin contained in the toner may be such a resin (A) or a part of the resin may be a resin (A).

The resin (A) preferably is a copolymer resin to satisfy characteristics required for a toner (for example, physical strength such as not peeling while forming a fixed image, heat fusibility such as being promptly fixed onto a support at a given heat energy, and electrical characteristics such as electrification).

The resin (A) of the present invention which contains a structure of an antioxidant moiety in the molecule of the resin not only inhibits oxidative degradation due to active species such as ozone or NO_{X} but also has a function of inhibiting oxidative deterioration of the surface of a carrier added together with a toner or the photoreceptor surface on which a primary image is formed with a toner through an electrostatic phenomenon.

Accordingly, such the resin (A) containing a structure of an antioxidant moiety in the resin molecule is preferably localized near the toner surface.

One embodiment of allowing a resin having a specific function to be localized near the toner particle surface is that toner particles have a core/shell structure.

In the present invention, there are preferably used toner particles of a core/shell structure comprising a core and further thereon a shell layer. Preferably, a resin contained in the shell layer comprises resin (A).

In the following, there will be described such the resin (A) and a production method of a toner having a core/shell structure, as one of preferred embodiments of the present invention.

### Resin (A):

In the structural unit represented by the foregoing formula (1) or (2), R₁ represents a hydrogen atom or an alkyl group having 1 to 8 carbon atoms, which may be substituted; R₂ is a hydrogen atom or an alkyl group having 1 to 8 carbon atoms which may be substituted, an alkoxy group having 1 to 8 carbon atoms which may be substituted, or a halogen atom; n is an integer of 0 to 2; L₁ is a linkage group or a bond; L₂ is a linkage group or a bond; and m is an integer of 1 to 3; m is an integer of 1 to 3; R₃ is a hydrogen atom, an alkyl group having 1 to 8 carbon atoms which may be substituted, or a linkage group or a bond.

Examples of an alkyl group represented by R₁ include methyl, ethyl, n-propyl, n-butyl, n-pentyl, n-hexyl, i-propyl, sec-butyl, and t-butyl groups, of which a t-butyl group is preferred.

Examples of an alkyl group represented by R₂ include alkyl groups cited in R₁. Examples of an alkoxy group methoxy, ethoxy, n-propyloxy and butyloxy.

Examples of a halogen atom include chlorine, bromine and iodine.

L₁ and L₂, each represents a linkage group or a bond. Examples of a linkage group include an alkylene group, —O—, —S— and —N(−)-; and preferred examples of an alkylene group include a methylene group, and an ethylene group.

The structural unit represented by the foregoing formula (1) exists as one part of side chains with respect to the main chain of a resin. The structural unit represented by the foregoing formula (2) exists as a side chain of a resin or one part of a main chain.

To allow the structural unit represented by the formula (1) or (2) to exist in a resin, there may be employed a technique of allowing a monomer containing these structural units to polymerize with another monomer, or a technique of allowing a resin containing a functional group to react with a compound containing a second functional group capable of reacting with the foregoing functional group and containing the structural unit of the formula (1) or (2).

Examples of a resin (A) include a polycondensation type resin such as a polyester resin, polyamide resin (A) and polyurethane resin (A) and a vinyl polymerization type resin such as a polystyrene resin, polyethylene resin, (meth)acrylate resin, vinyl chloride resin (A) and vinyl acetate resin, of which a polyester resin is specifically preferred.

Accordingly, polymerization, as described above, may be radical polymerization or cationic polymerization, or polycondensation, of which polycondensation is specifically preferred in the present invention. Namely, a polyester resin is preferably employed as a resin (A) related to the present invention. Such a polyester resin can be obtained by allowing a polyvalent alcohol component and a polyvalent carboxylic acid component to react with each other.

A polyester resin having a structure unit represented by the foregoing formula (1) or (2) can be obtained by performing a synthesis by using a compound having a structure represented by the formula (1) or (2) as the foregoing polyvalent alcohol component or polyvalent carboxylic acid component.

Using a polyvalent carboxylic acid compound and a polyvalent alcoholic compound, as exemplified below, polycondensation is performed, whereby a polyester resin having a structural unit represented by the formula (1) or the formula (2) can be prepared.

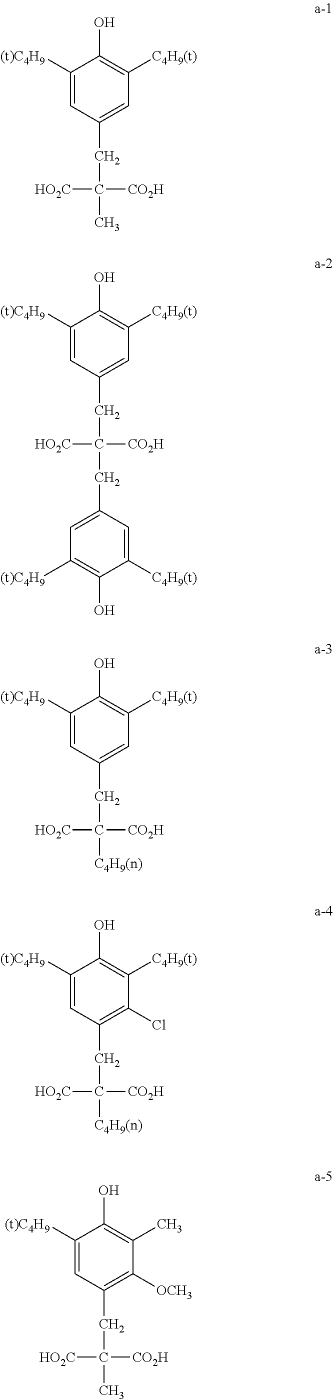

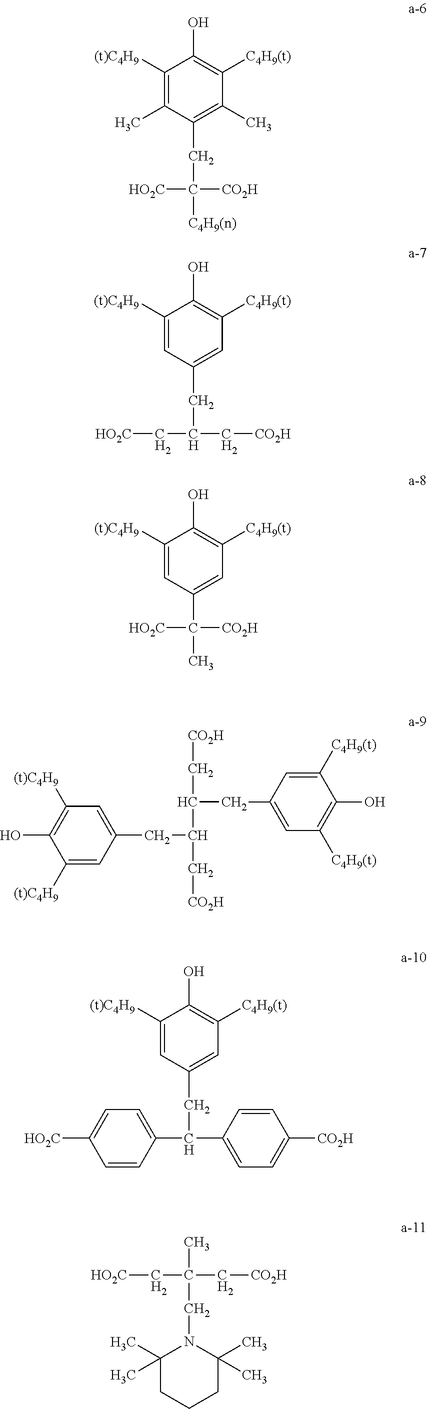

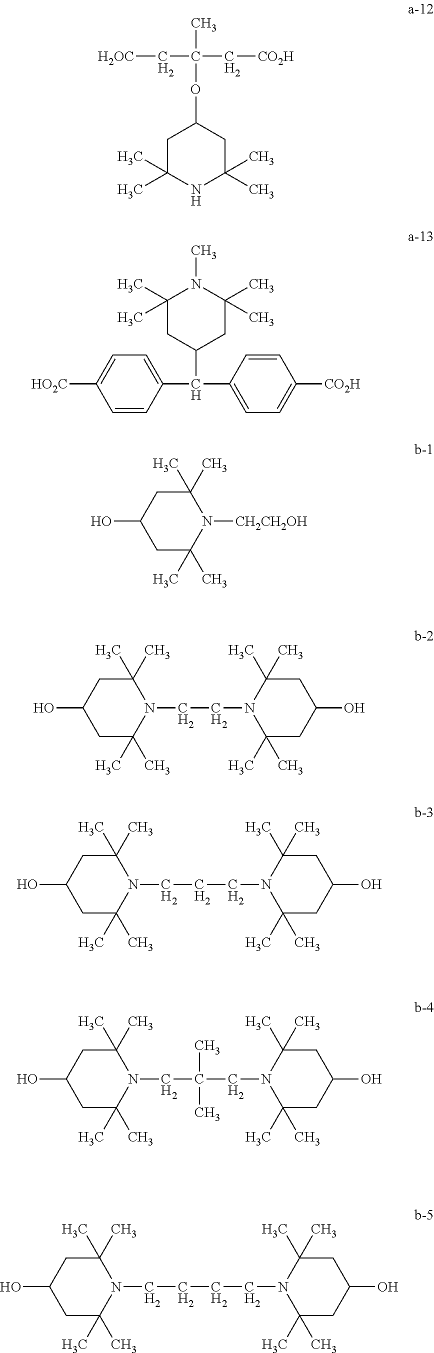

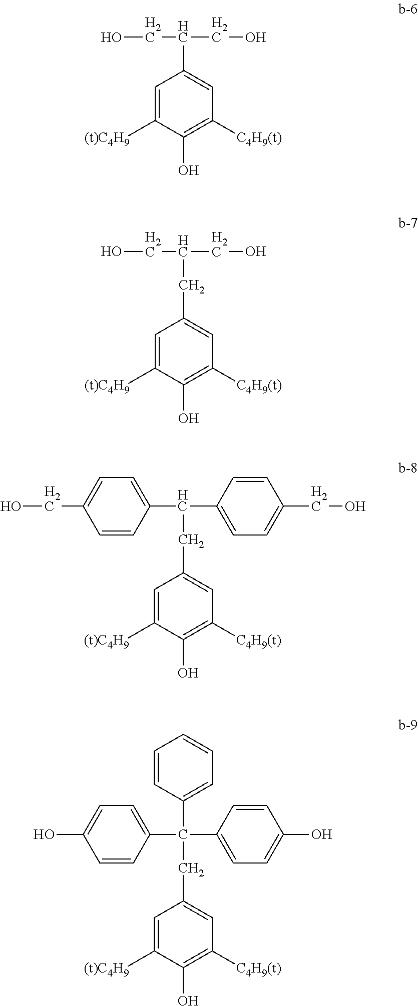

The polyester resin related to the present invention may be a polyester resin obtained by reacting only a polyvalent alcohol component and a polyvalent carboxylic acid component, but a polyester resin having a structural unit of a dicarboxylic acid (that is, containing two carboxylic acid groups) is preferable in terms of image sharpness.

Specific examples of a polyvalent alcohol component having an other structural unit for use in preparation of the polyester resin of the present invention include an aliphatic diol such as 1,2-propanediol, 1,3-propanediol, 1,4-butanediol, 1,5-pentanediol, 1,6-hexanediol, 1,7-heptanediol, 1,8-octanediol, neopentyl glycol, or 1,4-butenediol; an aromatic diol, such as bisphenol A and an alkyleneoxide adduct of bis phenol A; and a tri- or more valent alcohol, such as glycerin, pentaerythritol, trimethylolpropane or sorbitol.

Specific examples of a polyvalent carboxylic acid component having an other structural unit for use in preparation of the polyester resin of the present invention include a saturated aliphatic carboxylic acid, such as fumaric acid, maleic acid, oxalic acid, malonic acid, succinic acid, adipic acid, sebacic acid, azelaic acid, or n-dodecylsuccinic acid; an alicyclic dicarboxylic acid such as cyclohexanedicarboxylic acid; and an aromatic dicarboxylic acid such as phthalic acid, iso-phthalic acid or terephthalic acid. These may be used singly or in their combination.

A polyvalent alcohol and a polyvalent carboxylic acid, as described above are used so that an equivalence ratio of a hydroxyl group (OH) of a polyvalent alcohol to a carboxyl group (COOH) of a polyvalent carboxylic acid, that is, [OH]/[COOH] is preferably 1.5/1 to 1/1.5, and more preferably 1.2/1 to 1/1.2.

A polyester resin can be produced, for example, by subjecting the foregoing alcohol component and carboxylic acid component to polycondensation at a temperature of 120 to 250° C. in an inert gas atmosphere. In polycondensation, a catalyst for esterification may be used as needed.

The amount of a monomer having a structural unit represented by the foregoing formula (1) or (2) which is to be copolymerized to a polyester resin is preferably from 1 to 50% by mass and more preferably from 5 to 20% by mass, based on all of monomers (polyvalent alcohol component and polyvalent carboxylic acid) used for the polyester resin.

A polyester resin having a structural unit represented by the formula (1) or (2), as described above, is preferably used as a shell layer covering the toner particle surface.

In cases when the toner of the present invention is a core/shell type toner, the content of a resin contained in the shell layer is preferably from 0.5 to 20% by mass and more preferably from 1 to 10% by mass, based on all of toner particles.

Accordingly, the content of a resin site containing an antioxidative function structure is preferably from 0.05 to 2% by mass, based on all of toner particles, and more preferably, from 1 to 10% by mass.

In cases when the resin (A) is a vinyl polymer, a compound containing an unsaturated polymerizable linkage and having a structural unit represented by the formula (1) or (2) is used as a polymerizable monomer, and such a compound is polymerized or copolymerized, whereby a resin (A) is obtained.

In cases when such a compound is copolymerized, examples of an other monomer, that is, a copolymerizable monomer include styrene and its derivatives such as α-methylstyrene, p-chlorostyrene, p-ethylstyrene, and 2,4-dimethylstyrene; methacrylic acid and its derivatives such as methyl methacrylate, ethyl methacrylate, n-butyl methacrylate, iso-propyl methacrylate, iso-butyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylic acid and its acrylate such as methyl acrylate, ethyl acrylate, isopropyl acrylate, n-butyl acrylate, t-butyl acrylate, n-octyl acrylate, 2-ethylhexyl acrylate, stearyl acrylate, lauryl acrylate and phenyl acrylate.

Specific examples of a compound containing an unsaturated polymerizable linkage and having a structural unit represented by the formula (1) or (2) are shown below.

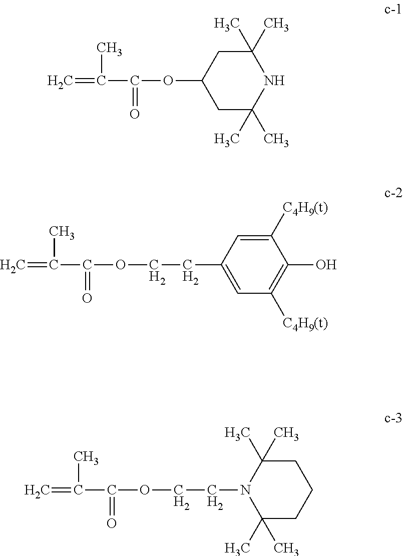

Further, in cases when the resin (A) is a vinyl polymer, a compound containing a reactive functional group and having a structural unit represented by the formula (1) or (2), for example, as shown below is allowed to polymerize to obtain a resin (A).

In that case, a basic polymer contains a functional group, for example, a hydroxyl group or a carbixy group, which is capable of reacting with the foregoing reactive functional group.

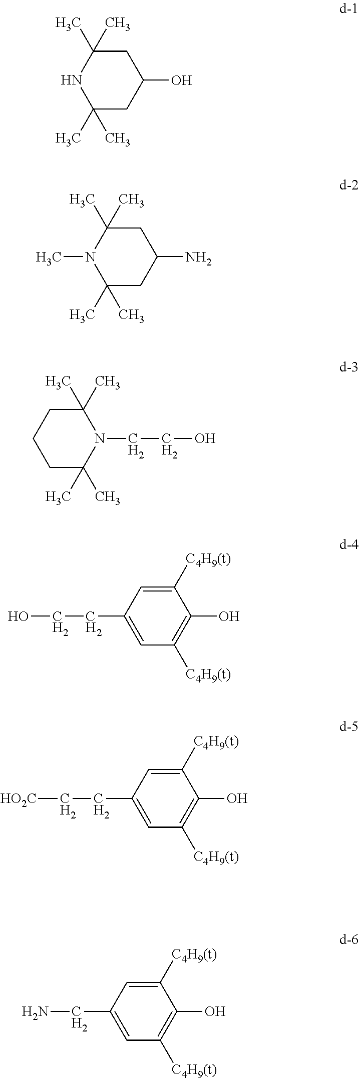

The resin (A) related to the present invention preferably exhibits a number average molecular weight (Mn) of 100 to 10,000, more preferably 800 to 5,000, and also preferably exhibits a weight average molecular weight (Mw) of 1,000 to 50,000 but more preferably 2,000 to 30,000, which are determined by gel permeation chromatography (GPC) of a tetrahydrofuran-soluble component.

The glass transition temperature (Tg) of the resin (A) related to the present invention preferably is from 20 to 90° C. but more preferably, from 45 to 75° C.

The softening point of the resin (A) related to the present invention preferably is from 80 to 220° C. but more preferably, from 80 to 150° C.

The glass transition point temperature (Tg) can be measured using a DSC-7 differential scanning colorimeter (DSC-7, produced by Perkin-Elmer Corp.) and thermal analysis controller (TAC7/DX, produced by Perkin-Elmer Corp.). Specifically, 4.50 mg of a toner is sealed into an aluminum pan (KIT No. 0219-0041) and set into a DSC-7 sample holder. An empty aluminum pan is used as a reference. The temperature is controlled through heating-cooling-heating (Heat-Cool-Heat) at a temperature-raising rate of 10° C./min and a temperature-lowering rate of 10° C./min in the range of 0 to 200° C. An extension line from the base-line prior to the initial rise of the first endothermic peak and a tangent line exhibiting the maximum slope between the initial rise and the peak are drawn and the intersection of both lines is defined as the glass transition point. After the first heating (1st Heat), the temperature was maintained at 200° C. over 5 minutes.

The softening temperature (Tsp) can be determined in the following manner. Under an environment of 20° C. and 50% RH, 1.1 g of a toner is placed into a petri dish and leveled off. After being allowed to stand for at least 12 hours, they are compressed for 30 sec. under a force of 3820 kg/cm² using a molding device SSP-A (produced by Shimazu Seisakusho) to prepare a cylindrical molded sample of a 1 cm diameter. Using a flow tester CFT-500D (produced by Shimazu Seisakusho) under an environment of 24±5° C. and 50±20%, the prepared sample was extruded through a cylindrical die using a piston of 1 cm diameter after completion of pre-heating under conditions of a load weight of 196 N (29 kgF), at an initial temperature of 60° C., a pre-heating time of 300 sec. and temperature-raising rate of 6° C./min. An offset method temperature (also denoted as T_{offset}), which is determined at an offset value of 5 mm in a melting temperature measurement method (temperature-raising method), is defined as the softening point.

### Production Method of Toner:

Toner particles, specifically, core/shell type toner particles are produced by the steps of:

1. Preparation of resin particle for a core,

2. Preparation of a colorant particle dispersion,

3. Preparation of core particle,

4. Preparation of resin particle for a shell layer,

5. Preparation of toner parent particle (particle having a core/shell structure), and

6. Preparation of toner.

In the following, there will be described a production method of a toner, as exemplified by production of toner particles having a core/shell structure which are preferably employed.

### Preparation of Resin Particle for a Core:

Specific examples of a resin used for a core include a polycondensation type resin such as polyester, polyamide, or polyurethane; and a vinyl polymerization type resin such as polyethylene, (meth)acrylate, vinyl chloride, or vinyl acetate.

These resins are used preferably in the form of particles and prepared preferably through emulsion polymerization, suspension polymerization or dispersion polymerization, in which resin particles are obtained as those dispersed in an aqueous medium.

Specific examples of a polymerizable monomer suitable for such emulsion polymerization include (1) styrene and styrene derivatives such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene; (2) methacryl acid ester derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; (3) acrylic acid ester derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; (4) olefins such as ethylene, propylene, and isopbutylene; (5) vinyl esters such as vinyl propionate, vinyl acetate, and vinyl benzoate; (6) vinyl ethers such as vinyl methyl ether, and vinyl ethyl ether; (7) vinyl ketones such as vinyl methyl ketone, vinyl ethyl ketone, and vinyl hexyl ketone; (8) N-vinyl compounds such as N-vinylcarbazole, N-vinylindole, and N-vinylpyrrolidone; (9) vinyl compounds such as vinylnaphthalene, and vinylpyridine; and (10) acrylic acid or methacrylic acid derivatives such as acrylonitrile, methacrylonitrile and acrylamide.

Polymerizable monomers forming a resin can also employ a polymerizable monomer containing an ionic dissociative group in combination.

Examples of such an ionic dissociative group include a carboxyl group, a sulfonic acid group or a phosphoric acid group, and a polymerizable monomer containing an ionic dissociative group contains the foregoing groups.

Specific examples of a monomer containing an ionic dissociative group include acrylic acid, methacrylic acid, maleic acid, itaconic acid, cinnamic acid, fumaric acid, maleic acid monoalkyl ester, itaconic acid monoalkyl ester, styrene sulfonic acid, allylsulfosuccinic acid, 2-acrylamido-2-methylpropane sulfonic acid, acidophosphooxyethyl methacrylate, and 3-chloro-2-acidophosphooxypropyl methacrylate.

In cases when it is necessary to allow a releasing agent to be contained in a core particle, a releasing agent is dissolved in a radical-polymerizable monomer and a releasing agent is added thereto to prepare a radical-polymerizable monomer solution, which is subjected to polymerization to prepare resin particles used for a core. Preferably, to an aqueous medium containing a surfactant at a concentration lower than its critical micelle concentration (CMC) is added a radical-polymerizable monomer solution, in which a releasing agent is dissolved or dispersed with applying mechanical energy to form liquid droplets and further thereto, an aqueous-soluble radical polymerization initiator is added to cause polymerization reaction to proceed within the liquid droplets.

An oil-soluble polymerization initiator may be in the foregoing liquid droplets. In this polymerization stage, it is dispensable to provide mechanical energy thereto to be forcedly emulsified to form liquid droplets. A means for providing such mechanical energy is one which provides strong stirring or ultrasonic oscillation energy, and including, for example, a homomixer, an ultrasonic wave and a Manton-Gaulin homogenizer.

Specific examples of a releasing agent include (1) long chain hydrocarbon wax, a polyolefin wax such as polyethylene wax and polypropylene wax, a paraffin wax and sasol wax; (2) ester wax such as trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol distearate, trimeritic acid tristearyl and distearyl maleate; (3) amide wax such as ethylenediamine dibehenylamide and trimeritic acid tristearylamide; (4) dialkylketone wax such as disteayl ketone; and (5) carnauba wax and montan wax.

The content of a releasing agent preferably is from 1 to 30% by mass of a toner, and more preferably from 5 to 20% by mass.

### Preparation of Colorant Particle Dispersion:

Colorants for use in the toner related to the present invention include those known in the art. Specific example thereof are shown below.

Examples of a colorant include, carbon black such as a furnace black, channel black, acetylene black, thermal black or lamp black, and a magnetic powder of magnetite or ferrite.

Examples of a magenta or red colorant include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48; 1, C. I. Pigment Red 53; 1, C. I. Pigment Red 57; 1, C. I. Pigment Red 122, C. I. Pigment Red 123, C. I. Pigment Red 139, C. I. Pigment Red 144, C.I. Pigment Red 149, C.I. Pigment Red 166, C. I. Pigment Red 177, C. I. Pigment Red 178, and C. I. Pigment Red 222.

Examples of an orange or yellow colorant include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 93, C. I. Pigment Yellow 94 and C. I. Pigment Yellow 138.

Examples of green or cyan colorant include C. I. Pigment Blue 15, C. I. Pigment Blue 15; 2, C. I. Pigment Blue 15; 3, C. I. Pigment Blue 15; 4, C. I. Pigment Blue 16, C. I. Pigment Blue 60, C. I. Pigment Blue 62, C. I. Pigment Blue 66 and C. I. Pigment Green 7.

These colorants are appropriately used singly or in their combination. A colorant is added to a toner preferably in an amount of 1 to 30% by mass of the toner, and more preferably 2 to 20% by mass. The number average primary particle size which is variable depending on the kind, is preferably in the range of 10 to 200 nm.

A colorant is used for formation of a toner in the form of a colorant particle dispersion.

Colorant particles are dispersed preferably in such a state that the surfactant concentration in water is more than the critical micelle concentration (CMC). Dispersing machines used for dispersion used for dispersion of colorant particles are not specifically limited, but preferred examples thereof include an ultrasonic dispersing machine, a mechanical homogenizer, a pressure dispersing machine such as Manton-Gaulin homogenizer or a pressure homogenizer, and a medium type dispersing machine such as a sand grinder, Gettsman mill or a diamod fine mill. There are also usable commonly known surfactants. Colorant particles may be subjected to surface modification.

### Preparation of Core Particle:

Core particles can be prepared by allowing resin particles for a core (hereinafter, also denoted as core resin particles) to be aggregated and fused in an aqueous medium in which the resin particles and colorant particles are present. Coagulation/fusion are preferably performed by a salting-out/fusion method.

In the coagulation/fusion step, a charge controlling agent or the like can be aggregated and fused together with core resin particles in an aqueous medium.

The expression “salting-out/fusion” refers to that coagulation and fusion proceed in parallel and when reaching an intended particle size, a coagulation terminating agent is added to stop particle growth and heating continues to control the shape of particles if needed.

The aqueous medium in the coagulation/fusion step refers to the main component (at least 50% by mass) being comprised of water. Components other than water include water-soluble organic solvents, such as methanol, ethanol, isopropanol, butanol, acetone, methyl ethyl ketone and tetrahydrofuran.

The salting-out/fusion method which is a preferable coagulation/fusion method is a process wherein, to an aqueous medium in which core resin particles and colorant particles are present is added a salting-out agent composed of an alkali metal salt, an alkaline earth metal salt or a trivalent metal salt, as a coagulant at a concentration more greater the critical coagulation concentration, and then heated at a temperature higher than the glass transition temperature of the core resin particles and lower than thea melting peak temperature (° C.), whereby salting-out proceeds and fusion is simultaneously performed.

In such an alkali metal salt and an alkaline earth metal, examples of an alkali metal include lithium, sodium and potassium, and examples of an alkaline earth metal include magnesium, calcium, strontium and barium, in which sodium, potassium, magnesium, calcium and barium are preferred.

### Production of Resin Particle for Shelling:

In the present invention, a shell layer preferably contains a resin (A).

Specifically, it is preferred to form toner particles in such a manner that, in the step of coagulation/fusion of an emulsion association type polymerization toner, a dispersion of resin particles for use in shelling is added to a core particle dispersion and the resin particles for shelling are coagulated and fused to cover the core particle surface to form a shell layer.

In the following, there will be exemplified use of a resin (A) of a polyester resin (A)s a resin for use in shell layer formation.

A polyester resin used for a shell layer is dispersed in an aqueous medium to prepare a polyester resin particle dispersion for use in the step of coagulation/fusion of an emulsion association type polymerization toner.

A polyester resin may be dissolved in a solvent such as ethyl acetate, dispersed in an aqueous medium by a dispersing machine and then subjected to a desolvation treatment.

Herein, the aqueous medium refers to water containing a dispersing agent such as a surfactant, in which an organic solvent such as an alcohol or a ketone may be dissolved in an amount of less than 50%.

A dispersion stabilizer may be dissolved in the aqueous medium, and a surfactant or resin particles may be added thereto for the purpose of achieving enhanced dispersion stability of oil droplets.

Examples of a dispersion stabilizer include inorganic compounds such as tricalcium phosphate, calcium carbonate, titanium oxide, colloidal silica, and hydroxyapatite. Since removal of a dispersion stabilizer from the obtained toner parent particles is required, it is preferred to use tricalcium phosphate or the like which is acid- or alkali-soluble.

Examples of surfactants include anionic surfactants such as alkylbenzenesulfonate, α-olefinsulfonate and a phosphoric acid ester; cationic surfactants of an amine salt type such as an alkylamine salt, an aminoalcohol carboxylic acid derivative, a polyamine carboxylic acid derivative or imidazolone, and a quaternary ammonium type such as an alkyltrimethylammonium, a dialkyldimethylammonium, an alkyldimethylbenzylammonium, a pyridinium salt, an alkylisoquilinium salt and benzethonium chloride; nonionic surfactants such as carboxylic acid amide derivatives and polyvalent alcohol derivatives; and amphoteric surfactants such as alanine, dodecyldi(aminoethyl)glycine, di(octylaminoethyl)glycine and N-alkyl-N,N-dimethylammoniumbetaine. There are also usable anionic or cationic surfactants containing a fluoroalkyl group.

Organic solvents for use in preparation of a polyester resin solution preferably are those exhibiting a low boiling point and low solubility in water from the view of easiness of removal after forming oil droplets. Specific examples of such an organic solvent include methyl acetate, ethyl acetate, methyl ethyl ketone, methyl isobutyl ketone, toluene, and xylene. These may used singly or in combination of two or more.

An aqueous medium is used preferably in an amount of 50 to 2,000 parts by mass, based on 100 parts by mass of a polyester resin solution, but more preferably, 100 to 1,000 parts by mass.

An amount of an aqueous medium falling within the above-described range makes it feasible to disperse a polyester resin solution in an aqueous medium to form an emulsion with desired emulsion particle sizes.

### Preparation of Toner Parent Particle:

Toner parent particles having a core/shell structure are formed in the manner that a dispersion of resin particles for shelling is added to a core particle dispersion and the resin particles are allowed to coagulate and fuse on the core resin particle surface to cover the core resin surface with the resin particles for shelling.

Preferably, the dispersion of resin particles used for a shell layer is added to the core particle dispersion with maintaining the temperature in the coagulation/fusion stage and the resin particles for shelling are allowed to slowly cover the core particle surface over a few hours with continuing heating and stirring to form toner parent particles. The duration for heating and stirring is preferably from one to seven hours, and more preferably, from three to five hours.

A terminating agent is added to terminate particle growth at the stage when toner parent particles reach a prescribed particle size through shelling, stirring is further continued over some hours to control the shape of toner parent particles of a core/shell structure.

Thereafter, a dispersion of the toner parent particles is subjected to a cooling treatment (rapid cooling treatment).

Thereafter, the toner parent particle dispersion cooled to the prescribed temperature is subjected to a solid/liquid separation treatment for separation of toner parent particles from the dispersion and a washing treatment to remove a surfactant or a coagulant from a separated toner cake (in which toner parent particles in a wet state are aggregated to a cake form).

Examples of a filtration treatment include a centrifugal treatment, vacuum filtration using a Nutsche funnel or the like and a filter press, but are not limited to these.

The thus washed toner cake is dried to form toner parent particles. Examples of a drying machine used for drying include a spray dryer, a vacuum freeze-drying machine, and a vacuum drying machine. There are also preferably employed a standing plate type dryer, a mobile standing plate type dryer, a fluidized-bed dryer, a rotary dryer, and a stirring dryer. The moisture content of the thus dried toner parent particles is preferably not more than 5% by mass and more preferably not more than 2% by mass.

In cases when the thus dried toner parent particles are aggregated through a weak interparticular attractive force, such an aggregate may be subjected to a pulverization treatment. An apparatus for such a pulverization treatment can employ a mechanical pulverizing apparatus such as a jet mill, a Henshell mixer, a coffee mill and a food processor.

Next, there will be described preparation of a toner.

### External Addition Treatment for Toner:

There may be added, to the toner of the present invention, an external additives to achieve an improvement of fluidity or electrostatic electrification property or an enhanced cleaning capability. Such external additives are not specifically restricted but include, for example, a variety of inorganic particles, organic particles and lubricants.

Such inorganic particles preferably employ inorganic oxide particles such as silica, titania or alumina, and these inorganic particles preferably are those which have been subjected to a hydrophobilizing treatment with a silane coupling agent, a titanium coupling agent or the like. Organic particles may employ spherical particles exhibiting a number average primary particle size of 10 to 2,000 nm. Such organic particles can employ a polymeric material such as polystyrene, polymethyl methacrylate) or a styrene-co-(methyl methacrylate).

Such external additives are added preferably in an amount of 0.1 to 5.0% by mass, based on the total amount of a toner, and more preferably, 0.5 to 4.0% by mass. There may be used various kinds of external additives in combination.

External additives or lubricants can be added by using a commonly known mixing device such as a tubular mixer, a Henshell mixer, a Nauta mixer and V-type mixing machine.

### EXAMPLES

The present invention will be further described with reference to the following specific examples, but the invention is by no means limited to these. Unless otherwise noted, “part(s)” represent parts by mass, and “%” represents % by mass.

### Preparation of Polyester Resin (A-1)-(A-6) for Shell Layer

### Preparation of Exemplified Compound a-1:

There was synthesized exemplified compound a-1, α-(3,5-di-t-butyl-4-hydroxyphenylmethyl)-α-methylmalonic acid, as below.

In 70 ml of 2-propanol were suspended 20.6 g (0.1 mol) of 2,6-di-t-butylphenol, 3.0 g (0.1 mol) of paraformaldehyde and 7.6 g (0.1 mol) of carbon disulfide, and further thereto, 7.3 g (0.1 mol) of diethylamine dissolved in 70 ml of 2-propanol was dropwise added and reacted under room temperature. Thereafter, the reaction mixture was refluxed with heating over 5 hours to complete the reaction. Subsequently, the solvent was removed and the obtained reaction product was dissolved in a solvent mixture of n-hexane and acetone and then recrystallized in an aqueous 60% 2-propanol solution to obtain, as an intermediate product, a dithiourea compound represented by the following formula (i-1):

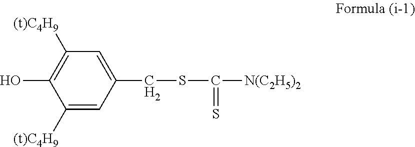

Subsequently, 17.4 g (0.1 mol) of diethyl methylmalonate and 36.7 g (0.1 mol) of the obtained intermediate product of a dithiourea compound were dissolved in 70 ml of 2-propanol, and thereto, 20 ml of an aqueous 20% sodium hydroxide solution was dropwise added with heating at 60° C. to perform reaction. Thereafter, refluxing was carried out with heating over 2 hours to complete reaction. After being allowed to stand with being cooled to 50° C., 120 ml of an aqueous 1% acetic acid solution was gradually added thereto. Then, the reaction mixture was cooled to 0° C. with stirring and precipitated crystals were filtered off; washed with an aqueous 60% 2-propanol solution and dried to obtain α-(3,5-di-t-butyl-4-hydroxyphenylmethyl)-α-methylmalonic acid diethyl ester at a yield of 90%.

The thus obtained ester was hydrolyzed to obtain, as an objective compound, exemplified compound a-1, α-(3,5-di-t-butyl-4-hydroxyphenylmethyl)-α-methylmalonic acid. The yield was 90%.

### Preparation of Exemplified Compound a-2:

In 70 ml of 2-propanol were dissolved 8.0 g (0.05 mol) of diethyl malonate and 36.7 g (0.1 mol) of the obtained intermediate product of a dithiourea compound (structure formula i-1) and thereto, 20 ml of an aqueous 20% sodium hydroxide solution was dropwise added with heating at 60° C. to perform reaction. Thereafter, refluxing was carried out with heating over 2 hours to complete reaction. After allowed to stand with being cooled to 50° C., 120 ml of an aqueous 1% acetic acid solution was gradually added thereto. Then, the reaction mixture was cooled to 0° C. with stirring and precipitated crystals were filtered off, washed with an aqueous 60% 2-propanol solution and dried to obtain α,′α-bis(3,5-di-t-butyl-4-hydroxyphenylmethyl)malonic acid diethyl ester (exemplified compound a-2) at a yield of 75%.

The thus obtained ester was hydrolyzed to obtain, as an objective compound, exemplified compound a-2, α-bis(3,5-di-t-butyl-4-hydroxyphenylmethyl)-α-methylmalonic acid. The yield was 90%.

### Preparation of Exemplified Compound b-1:

To an autoclave (heating and pressure reactor vessel) were added 15.7 g (0.1 mol) of tetramethylpiperidinol and 100 ml of 2-propanol and after 22.0 g (0.5 mole) of ethylene oxide gas was further added thereto, reaction was performed at 160° C. under pressure over 6 hours.

After cooling the reaction mixture and then removing a solvent, the obtained reaction product was subjected to recrystallization in n-hexane, whereby 1-hydroxyethyl-2,2,6,6-tetramethyl-4-piperidinol (exemplified compound b-1) was obtained at a yield of 70%.

### Preparation of Exemplified Compound b-2

In 300 ml of ethanol were dissolved 8.6 g (0.05 mol) of N-methylpiperidinol and 9.1 g (0.05 mol) of benzophenone and reacted in a photoreaction vessel fitted with a high-pressure mercury lamp over 3 days under room temperature. After removal of a solvent from the reaction mixture, the reaction product was separated in silica gel column chromatography (solvent: n-hexane/acetone), whereby exemplified compound b-2, as an objective compound, ethylenebis-(4-hydroxy-2,2,6,6-tetamethyl-4-piperidine-1-yl) at a yield of 40%.

### Preparation of Polyester Resin (A-1) for Shelling:

### Polyvalent Carboxylic Acid Monomer

| | |
|---|---|
| Succinic acid | 10 parts |
| Terephthalic acid | 35 parts |
| α-(3,5-di-t-butyl-4-hydroxyphenylmethyl)- | 5 parts |
| α-methylmalonic acid (exemplified compound a-1) | |

### Polyvalent Alcohol Monomer

| | |
|---|---|
| Propylene oxide (2 mole) adduct of | 76 parts |
| 2,2-Bis(4-hydroxyphenyl)propane | |
| 2,2-Bis(4-hydroxyphenyl)propane | 20 parts |

Into a reactor vessel fitted with a stirrer, a nitrogen-introducing tube, a temperature sensor and a condenser were added the foregoing polyvalent carboxylic acid monomers and polyvalent alcohol monomers and heated to 190° C. over 1 hour. After confirming that the reaction mixture was homogeneously stirred, a catalyst of Ti(OBu)₄ was added thereto in an amount of 0.003% by mass, based on total amount of polyvalent carboxylic acid monomers.

Further, the temperature was raised from 190° C. to 240° C. over 6 hours, while distilling out formed water and dehydration condensation reaction continued at 240° C. over 6 hours to perform polymerization, whereby polyester resin (A-1) used for shelling was obtained.

The molecular weight of the thus obtained polyester resin (A-1) for use in shelling was 3800, which was determined through gel permeation chromatography (GPC, HLC-8 and 120 GPC, made by TOSO Co., Ltd., converted by using a styrene standard material). The glass transition temperature (Tg) and softening point were 66° C. and 114° C., respectively.

### Preparation of Polyester Resin (A-2) for Shelling:

Polyester resin (A-2) used for shelling was prepared in the same manner as the foregoing polyester resin (A-1), except that a polyvalent carboxylic acid monomer and a polyvalent alcohol monomer were changed as below. The thus prepared polyester resin (A-2) exhibited a number average molecular weight of 4300, a glass transition temperature (Tg) of 52° C. and a softening point of 101° C.

### Polyvalent Carboxylic Acid Monomer

| | |
|---|---|
| Succinic acid | 10 parts |
| Terephthalic acid | 40 parts |

### Polyvalent Alcohol Monomer

| | |
|---|---|
| Propylene oxide (2 mole) adduct of | 85 parts |
| 2,2-Bis(4-hydroxyphenyl)propane | |
| 2,2-Bis(4-hydroxyphenyl)propane | 10 parts |
| 1-Hydroxyethyl-2,2,6,6-tetramethyl-4- | 6 parts |
| piperidinol (exemplified compound b-1) | |

### Preparation of Polyester Resin (A-3) for Shelling:

Polyester resin (A-3) used for shelling was prepared in the same manner as the foregoing polyester resin (A-1), except that a polyvalent carboxylic acid monomer and a polyvalent alcohol monomer were changed as below. The thus prepared polyester resin (A-3) exhibited a number average molecular weight of 4000, a glass transition temperature (Tg) of 62° C. and a softening point of 110° C.

### Polyvalent Carboxylic Acid Monomer

| | |
|---|---|
| Succinic acid | 10 parts |
| Terephthalic acid | 35 parts |
| α-(3,5-di-t-butyl-4-hydroxyphenylmethyl)- | 5 parts |
| α-methylmalonic acid (exemplified compound a-1) | |

### Polyvalent Alcohol Monomer

| | |
|---|---|
| Propylene oxide (2 mole) adduct of | 75 parts |
| 2,2-bis(4-hydroxyphenyl)propane | |
| 2,2-Bis(4-hydroxyphenyl)propane | 18 parts |
| 1-Hydroxyethyl-2,2,6,6-tetramethyl-4- | 3 parts |
| piperidinol (exemplified compound b-1) | |

### Preparation of Polyester Resin (A-4) for Shelling:

Polyester resin (A-4) used for shelling was prepared in the same manner as the foregoing polyester resin (A-1), except that a polyvalent carboxylic acid monomer and a polyvalent alcohol monomer were changed as below. The thus prepared polyester resin (A-4) exhibited a number average molecular weight of 4500, a glass transition temperature (Tg) of 58° C. and a softening point of 105° C.

### Polyvalent Carboxylic Acid Monomer

| | |
|---|---|
| Succinic acid | 10 parts |
| Terephthalic acid | 40 parts |

### Polyvalent Alcohol Monomer

| | |
|---|---|
| Propylene oxide (2 mole) adduct of | 75 parts |
| 2,2-Bis(4-hydroxyphenyl)propane | |
| 2,2-Bis(4-hydroxyphenyl)propane | 15 parts |
| Ethylene-bis(4-hydroxy-2,2,6,6-tetramethyl- | 10 parts |
| 4-piperidine-1-yl) (exemplified compound b-2) | |

### Preparation of Polyester Resin (A-5) for Shelling:

Polyester resin (A-5) used for shelling was prepared in the same manner as the foregoing polyester resin (A-1), except that a polyvalent carboxylic acid monomer and a polyvalent alcohol monomer were changed as below. The thus prepared polyester resin (A-5) exhibited a number average molecular weight of 4500, a glass transition temperature (Tg) of 67° C. and a softening point of 118° C.

### Polyvalent Carboxylic Acid Monomer

| | |
|---|---|
| Succinic acid | 10 parts |
| Terephthalic acid | 35 parts |
| α,α-bis(3,5-di-t-butyl-4-hydroxyphenylmethyl)- | 5 parts |
| malonic acid (exemplified compound a-2) | |

### Polyvalent Alcohol Monomer

| | |
|---|---|
| Propylene oxide (2 mole) adduct of | 75 parts |
| 2,2-bis(4-hydroxyphenyl)propane | |
| 2,2-Bis(4-hydroxyphenyl)propane | 20 parts |
| Ethylene-bis(4-hydroxy-2,2,6,6-tetramethyl- | 5 parts |
| 4-piperidine-1-yl) (exemplified compound b-2) | |

### Preparation of Polyester Resin (A-6) for Shelling:

Polyester resin (A-6) used for shelling, for comparison, was prepared in the same manner as the foregoing polyester resin (A-1), except that a polyvalent carboxylic acid monomer and a polyvalent alcohol monomer were changed as below. The thus prepared polyester resin (A-6) exhibited a number average molecular weight of 4100, a glass transition temperature (Tg) of 71° C. and a softening point of 122° C.

### Polyvalent Carboxylic Acid Monomer

| | |
|---|---|
| Succinic acid | 10 parts |
| Terephthalic acid | 38 parts |

### Polyvalent Alcohol Monomer

| | |
|---|---|
| Propylene oxide (2 mole) adduct of | 76 parts |
| 2,2-bis(4-hydroxyphenyl)propane | |
| 2,2-Bis(4-hydroxyphenyl)propane | 20 parts |

### Preparation of Polyester Resin for Shell

### Preparation of Polyester Resin (A-1) Dispersion:

To 1700 parts by mass of ethyl acetate was added 400 parts by mass of the thus obtained polyester resin (A-1) and the mixture was heated to 70° C. with stirring to prepare a polyester resin solution for use in shell layer formation.

Meanwhile, 4.8 parts by mass of sodium dodecylsulfate was dissolved in 2000 parts by mass of deionized water in another reactor vessel to prepare an aqueous medium. Further thereto was added the foregoing polyester resin solution for a shell layer and stirred by a mixer (TK Homomixer Mark II Type 2.5, produced by Primix Inc.) to obtain a dispersion in which polyester resin solution was dispersed in the fowl of oil-droplets in an aqueous medium.

Thereafter, ethyl acetate was distilled out under reduced pressure with stirring at 50° C. to remove ethyl acetate, whereby a dispersion of polyester resin (A-1) particles used for a shell layer, exhibiting a volume-based median diameter of 240 nm was obtained.

### Preparation of Polyester Resin (A-2) Dispersion:

A dispersion of polyester resin (A-2) used for a shell layer was prepared similarly to the foregoing dispersion of polyester resin (A-1), and exhibiting a volume-based median diameter of 190 nm.

### Preparation of Polyester Resin (A-3) Dispersion:

A dispersion of polyester resin (A-3) used for a shell layer was prepared similarly to the dispersion of polyester resin (A-1), and exhibiting a volume-based median diameter of 218 nm.

### Preparation of Polyester Resin (A-4) Dispersion:

A dispersion of polyester resin (A-4) used for a shell layer was prepared similarly to the dispersion of polyester resin (A-1), and exhibiting a volume-based median diameter of 185 nm.

### Preparation of Polyester Resin (A-5) Dispersion:

A dispersion of polyester resin (A-5) used for a shell layer was prepared similarly to the dispersion of polyester resin (A-1), and exhibiting a volume-based median diameter of 193 nm.

### Preparation of Polyester Resin (A-6) Dispersion:

A dispersion of polyester resin (A-6) used for a shell layer was prepared similarly to the dispersion of polyester resin (A-1), and exhibiting a volume-based median diameter of 235 nm.

### Preparation of Resin Particle Dispersion

Particulate resin used for a core was prepared through two step polymerization.

### First Polymerization Step:

Into a reactor vessel fitted with a stirrer, a temperature sensor, a condenser and a nitrogen gas-introducing device was added a solution of 7 parts by mass of polyoxyethylene (2) dodecyl ether sodium sulfate dissolved in 1000 parts by mass of deionized water and heated to 80° C. Further thereto was added a monomer mixture used for the first polymerization step which was previously dissolved at 75° C. and dispersed over one hour by using a dispersing machine (CLEARMIX, produced by M TECHNIQUE Co., Ltd.) to prepare a dispersion containing emulsified particles (oil droplets).

Subsequently, to this dispersion was added a polymerization initiator solution of 6 parts by mass of potassium persulfate dissolved in 120 parts by mass of deionized water and heated at 82° C. over one hour to perform polymerization.

### Monomer Mixture for First Polymerization Step

| | | |
|---|---|---|
| Styrene | 150 | parts |
| n-Butyl acrylate | 70 | parts |
| Methacrylic acid | 7 | parts |
| n-Octylmercaptan | 2.8 | parts |
| Releasing agent (pentaerythritol | 120 | parts |
| tetrabehenate) | | |

### Second Polymerization Step:

Further thereto, a solution of 8 parts by mass of potassium persulfate dissolved in 160 parts by mass of deionized water was added and a monomer mixture used for the second polymerization, as described below, was added over one hour under a temperature condition of 82° C.

After completing addition, stirring was conducted with heating over two hours to perform polymerization and then, the reaction mixture was cooled to 40° C. to obtain a resin particle solution, which was denoted as a resin particle dispersion for core.

### Monomer Mixture for Second Polymerization

| | | |
|---|---|---|
| Styrene | 260 | parts |
| n-Butyl acrylate | 105 | parts |
| Methacrylic acid | 12 | parts |
| n-Octylmercaptan | 5 | parts |

### Preparation of Colorant Particle Dispersion:

In 1600 parts by mass of deionized water was dissolved 90 parts by mass of sodium dodecylsulfate. Further thereto, 420 parts by mass of carbon black of a pH of 2.5 (Carbon Black #1000, produced by Mitsubishi Kasesi Co., Ltd.) was gradually added and then dispersed by using a stirring machine (CLEARMIX, produced by M TECHNIQUE Co., Ltd.) to prepare a colorant particle dispersion. The thus prepared dispersion was measured with respect to colorant particle size by using an electrophoretic light scattering photometer (ELS-800, produced by Otsuka Denshi Co., Ltd.) and it was proved to be 110 nm.

Toner 1 was prepared according the steps below.

### Coagulation/Fusion:

Into a reactor vessel fitted with a stirrer, a temperature sensor, a condenser and a nitrogen gas-introducing device were added 340 parts by mass of solids of the foregoing resin particle dispersion for the core, 1000 parts by mass of deionized water and 42 parts by mass of solids of the colorant particle dispersion, and after the liquid temperature was adjusted to 30° C., the pH was controlled to 10 with an aqueous 5N sodium hydroxide solution.

Subsequently, an aqueous solution of 60 parts by mass of magnesium chloride which was dissolved in 60 parts by mass of deionized water was added at 30° C. over 10 minutes with stirring at 230 rpm.

After stirring over 3 minutes, the solution was heated to 90° C. over 60 minutes and after completion of heating, the stirring rate was reduced to 170 rpm and the temperature was maintained at 90° C. to perform growth reaction of core particles.

At the time when the volume-based median diameter (D₅₀) reached 6.5 μm, the stirring rate was raised to 280 rpm, and the dispersion of polyester resin (A-1) used for the shell was added in an amount of 40% solids by mass over 10 minutes and resin particles for the shell were allowed to adhere around the core particle to perform shelling. At 120 minutes after adding the resin particle dispersion for a shell layer, an aqueous solution of 80 parts by mass of sodium chloride which was dissolved in 400 parts by mass of deionized water, was added thereto to terminate the shelling reaction, and stirring with heating at 92° C., as a fusion step was conducted and fusion between particles was promoted until the circularity which was determined by FPIA-2100 reached 0.945. Thereafter, the liquid temperature was lowered to 30° C., the pH was adjusted to 4.0 with hydrochloric acid and stirring was stopped, whereby a dispersion of particles of a core/shell structure was obtained. The thus obtained dispersion was denoted as dispersion of toner parent particle 1.

### Washing/Drying:

The dispersion of toner parent particle 1, obtained in the coagulation/fusion step was subjected to solid/liquid separation in a basket centrifuge (MARK III Type No. 60×40, produced by Matsumoto Kikai Co., Ltd.) to form a wet cake of toner parent particles.

The thus formed wet cake was washed with deionized 40° C. water in the basket centrifuge until the conductivity of the filtrate reached 5 μS/cm, transported to Flash Jet Dryer (produced by Seishin Kigyo Co., Ltd.) and dried until reached a moisture content of not more than 1% by mass, whereby toner parent particle 1 was obtained.

### External Additive Treatment:

To the thus obtained toner parent particle 1 were added a hydrophobic silica (number average primary particle size of 12 nm) and hydrophobic titania (number average primary particle size of 20 nm) in amounts of 1% by mass and 0.3% by mass, respectively, and mixed in a Henshell mixer to obtain Toner 1.

### Preparation of Toners 2-7:

Toner 2 through Toner 6 were each prepared in the same manner as Toner 1, except that the dispersion of polyester resin (A-1) used for a shell layer was changed to each of dispersions of polyester resins (A-2) to (A-6).

Toner 7 was prepared in the same manner as Toner 6, except that an external additive treatment was conducted in such a manner that a hydrophobic silica (number average primary particle size of 12 nm) and a hydrophobic titania (number average primary particle size of 20 nm) were added in amounts of 1% by mass and 0.3% by mass, respectively, and mixed in a Henshell mixer, and a particulate mixture of 6 parts by mass of an aliphatic alcohol type antioxidant (Unilin 425 alcohol, produced by TOYO PETOLITE Co., Ltd) and 4 parts by mass of a phenolic antioxidant (Sumilizer MDP-S, produced by Kyodo Yakuhin Co., Ltd.) was mixed in a Henshell mixer.

### Evaluation

### Evaluation of Latitude in Environmental Conditions:

Evaluation was made with respect to image unsharpness and electrostatic charge under the environmental conditions below, providing an indication for latitude in environmental conditions.

### Image Sharpness:

Using a printer (bizhub PRO 1050, produced by Konica Minolta Business Technology Inc.), 5,000 sheets of a character image at a print ratio of 10% were printed under high temperature and high humidity (38° C., 80% RH) and after being allowed to stand overnight, a halftone image was printed and evaluated with respect to image unsharpness immediately below a charging electrode, based on the following criteria:

A: A halftone image giving rise no unsharpness immediately below a charging electrode and being normal,

B: A halftone image becoming thin immediately below a charging electrode,

C: A halftone image becoming white immediately below a charging electrode.

### Electrostatic Charge of Toner:

Into a 20 ml glass vessel 19 g of a carrier and 1 g of a toner were placed and vibrated over 20 minutes by a 50 cm long arm at an angle of 45 degrees and a rate of 200 times per minute under two environments (UL environment, H/H environment), as described below, and thereafter, the electrostatic charge was measured by a blow-off method;

UL environment, set to an atmosphere of 10° C. and 10% RH,

H/H environment, set to an atmosphere of 30° C. and 85% RH.

Evaluation was made based on the difference in electrostatic charge between the L/L environment and the H/H environment, according to the following criteria:

Not less than 2 μC/g but less than 8 μC/g (excellent),

Not less than 8 μC/g and less than 12 μC/g (acceptable in practice),

Not less than 12 μC/g (unacceptable in practice).

### Stability of Outputted Image:

A printing run of a lot of sheets was conducted under the environment below and evaluated with respect to fogging and granular appearance of images, as a measure of stability of output images.

After continuous-printing of 100,000 sheets of character images at a print ratio of 10% was run under the foregoing L/L environment (10° C., 10% RH) or H/H environment (30° C., 85% RH), printed images were visually observed and evaluated with respect to fogging of the white background and granular appearance of halftone images, based on the following criteria.

### Fogging:

A: Any of lowering of image density and fogging was not observed,

B: Lowering of image density and/or fogging were slightly observed by a 20-fold magnifier but was at a level of being acceptable in practice,

C: Lowering of image density and fogging were observed and was at a level of being unacceptable in practice.

### Image Appearance:

A print with an overall halftone image (having a reflection density of 0.4) was outputted and was visually evaluated with respect to extent of fineness of the obtained halftone image, based on the criteria below:

A: A uniform and fine halftone image being reproduced,

B: Slightly granular appearance of a halftone image, which is invisible to the naked eye but observed with a magnifier,

C: Granular appearance which is visible to the naked eye, and resulting in a rough image.

Evaluation results are shown in Table 1.

TABLE 1

| | | Difference in Electro- | | | |
|---|---|---|---|---|---|
| Toner | Image | static Charge between | Fog- | Image | |
| No | Sharpness | Environments (μC/g) | ging | Appearance | Remark |
| 1 | A | 3.7 | A | B | Inv. |
| 2 | B | 5.2 | B | A | Inv. |
| 3 | A | 2.8 | A | A | Inv. |
| 4 | B | 6.5 | B | B | Inv. |
| 5 | A | 3.1 | A | A | Inv. |
| 6 | C | 14.0 | C | C | Comp. |
| 7 | B | 19.0 | C | C | Comp. |

As is apparent from Table 1, it was proved that images formed by use of the toner of the present invention were superior in image quality and excellent images were obtained even after a large number of sheets were printed, leading to enhanced stability in outputting images.

What is claimed is:

1. A toner for electrostatic image development, wherein the toner comprises a resin and a colorant, and the resin comprises a resin (A) having a structural unit represented by the following formula (1) or formula (2): 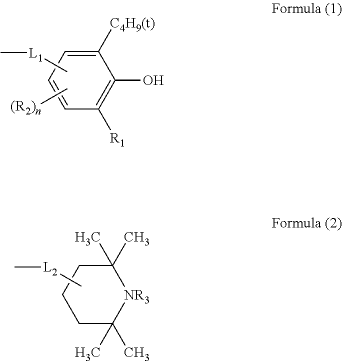
wherein R₁ is a hydrogen atom or an alkyl group having 1 to 8 carbon atoms; R₂ is an alkyl group having 1 to 8 carbon atoms, an alkoxy group having 1 to 8 carbon atoms or a halogen atom; n is an integer of 0 to 2; L₁ is a linkage group or a bond; L₂ is a linkage group or a bond; R₃ is a hydrogen atom, an alkyl group having 1 to 8 carbon atoms, or a linkage group or a bond.

2. The toner of claim 1, wherein the toner comprises toner particles having a core/shell structure which is comprised of a core and further thereon a shell.

3. The toner of claim 1, wherein the toner comprises toner particles having a core/shell structure which is comprised of a core and further thereon a shell, and the shell comprises the resin (A).

4. The toner of claim 1, wherein the resin (A) is a polycondensation resin.

5. The toner of claim 1, wherein the resin (A) is a polyester resin.

6. The toner of claim 1, wherein the resin (A) is a polyester resin having a structural unit represented by the formula (1).

7. The toner of claim 6, wherein the polyester resin has a structural unit of a dicarboxylic acid.

8. The toner of claim 1, wherein in the formula (1), R₁ is a t-butyl group.

9. The toner of claim 5, wherein a monomer component having a structural unit represented by the formula (1) or (2) accounts for 1 to 50% by mass of all of monomer components forming the polyester resin.

10. The toner of claim 5, wherein a monomer component having a structural unit represented by the formula (1) or (2) accounts for 5 to 20% by mass of all of monomer components forming the polyester resin.

11. The toner of claim 1, wherein the toner contains the structural unit represented by the formula (1) or (2) in an amount of 0.05 to 2% by mass.
